(19) United States
(12) Patent Application Publication
(10) Pub. No.: US 2002/0101545 A1
(43) Pub. Date: Aug. 1, 2002

(54) Wireless transmission system

(76) Inventor: Nicolaas Johannes Damstra, Breda (NL)

Correspondence Address: U.S. Philips Corporation, 580 White Plains Road, Tarrytown, NY, 10591, US

(21) Appl. No.: 10/060,677

(22) Filed: Jan. 30, 2002

(30) Foreign Application Priority Data
Jan. 30, 2001 (EP) 01200319.0

(51) Int. Cl. H04N 5/455

(52) U.S. Cl. 348/726

(57) ABSTRACT

The invention relates to a digital video and/or audio transmission system. To improve such a system the invention proposes to use for the compressing/decompressing the so-called DVCPRO standard (till the error correction) and use the so-called COFDM standard for the modulation/demodulation.

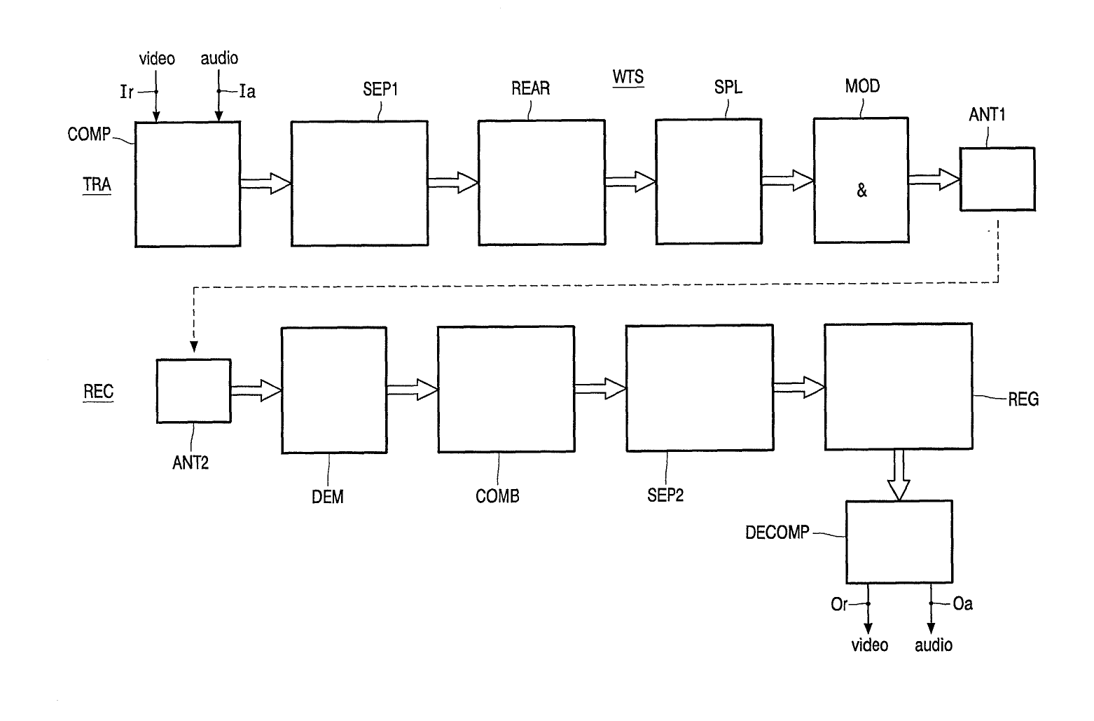

The DVCPRO compression/decompression adds very little delay in the transmission chain and supplies a very reasonable video quality. Further the COFDM is very robust for multi path transmission and does not result in picture quality loss as long as the maximal bit error rate is taken care of. Further it was not obvious to use this combination because the DVCPRO standard is principle optimized for tape use.

### The invention relates to a wireless transmission system for transmitting video and/or audio signals from a camera.

The invention further relates to a transmitter and a receiver for use in such a wireless transmission system.

The invention further relates to a method for transmitting video and/or audio signals from a camera.

From GB-A-2332124 a digital radio communication system is known having a mobile transmitter which transmits error protected digital data on a plurality of radio carriers to a plurality of receiving antennas. The receiving antennas are coupled to summation means to be combined to produce an output signal. The output signal is supplied to a multi carrier receiver to decode the original digital data. This known digital radio communication system can only be used for radio transmission and can thus not be used for transmission of digital video.

It is inter alia an object of the invention to obtain a wireless transmission system for wireless digital transmission of video and/or audio signals. It will be realized that transmitting digital video signals has much higher requirements than transmitting radio signals as the prior art describes.

A first aspect of the invention provides a wireless transmitting system comprising the features of claim 1. A second aspect of the invention provides a method of transmitting video and/or audio signals comprising the features of claim 5.

The invention is based on the inside that by combining the so-called DVCPRO (digital video compression professional) standard for compressing/decompressing and by using the so-called COFDM (coded orthogonal frequency division multiplexing) standard for modulation/demodulation a very advantageous wireless transmitting system can be obtained. Reference is made to the European Standard ETSI EN300744 and SMPTE 307M-1998 Television Digital Recording (Tape Cassette).

The DVCPRO compression/decompression adds very little delay in the transmission chain and supplies a very reasonable video quality. Further the COFDM is very robust for multi path transmission and does not result in picture quality loss as long as the maximal bit error rate is taken care of. Further it was not obvious to use this combination because the DVCPRO standard is principle optimized for tape use.

Embodiments of the invention are defined in the dependent claims.

These and other aspects of the invention will be described hereinafter by way of example of the following description. Herein shows the Figure:

Block schematically a wireless transmission system according to the invention.

The Figure shows block schematically the wireless transmission system according to the invention. At inputs Iv and Ia the system WTS receives respectively a video signal and an audio signal. These two input signals are compressed using the so-called DVCPRO standard, whereby the compression is performed till the adding of error correction bits. The error correction bits are not performed according to the DVCPRO standard because these error corrections are optimized for tape storage and not for wireless transmission.

This data stream which is available after compression is splitted whereby the blanks and overhead is removed. This results in real data and frame information. By deleting the blanks and overhead the data rate can be kept as low as possible.

The real data content is supplied to a re-arrange unit to re-arrange the data into MPEG-structure. The MPEG packets are splitted into two streams and these two streams are supplied to a modulation unit for modulation according to the COFDM standard. After modulation the wireless transmission system comprises a RF part for making the signal ready for transmitting via antenna ANT1.

A receiver REC of the wireless transmission system also comprises an antenna ANT2, which antenna receives the signal as transmitted by the transmitter TRA. In the receiver the signal is supplied to a demodulation unit comprising also a RF part.

The demodulation is also performed according to the COFDM standard. The resulting two streams are combined in combiner COMB to one stream of MPEG packets.

This stream is supplied to a separation unit SEP2 to take the real DVCPRO data, frame information and auxiliary data out of the MPEG structure. The separation unit is coupled to a regenerate unit REG to regenerate DVCPRO compressed stream from real data and frame information.

The regeneration unit is coupled to a decompress unit DECOMP to decompress the DVCPRO signal to obtain at outputs Ov and Oa respectively a video output and an audio output signal.

For example the MPEG transport stream structure has the following structure

47HEX (packet header)

Frame start indication (1 byte)

Packet counter (1 byte)

Number of DVCPRO data byte in this packet (1 byte)

Number of auxiliary data bytes in this packet (1 byte)

DVCPRO data bytes

Auxiliary data bytes

Stuff bytes

The total number of bytes is in this example always 188.

Auxiliary data can for example be user's pacific control signals to control the camera and/or the other devices via the wireless transmission. The packet counter can be used to split the MPEG packets in two streams of for example 14.4 megabit/seconds. By splitting these stream to choose options between the DVB-T standard to perform a robust transmission.

At the receiver's side both MPEG streams delivered by the DVB-T modulators are supplied in the right sequence and combined and subsequently the MPEG structure is separated. This results in the availability of the real DVCPRO data content, (video plus audio), frame information to be used for synchronization and the auxiliary data.

On the basis of the real DVCPRO data content and the frame information the DVCPRO decompressed signal is regenerated and supplied to the DVCPRO decompression whereafter the video and audio are available.

The man skilled in the art will be well aware of a lot of amendments falling within the scope of the invention. The main idea of the invention is to use the DVCPRO standard for the compressing/decompressing (till the error correction, which is in this standard specific for tape applications) and the COFDM standard for the modulation/demodulation.

1. Wireless transmission system for transmitting video and/or audio signals of at least one camera, comprising a transmitter with compression means for compressing the input signals, modulation means for modulation decompressed signals and an RF unit coupled to a first antenna, a receiver with a second antenna, a second RF unit, demodulation means for demodulating the received signal, decompressing means for decompressing the demodulated signal, whereby the compressing/decompressing means used the DVCPRO standard and the modulation/demodulation means use the COFDM standard.

2. Wireless transmission system according to claim 1 characterized in that the camera comprises the transmitter.

3. Transmitter for use in a wireless transmission system as claimed in claim 1.

4. Receiver for use in a wireless transmission system as claimed in claim 1.

5. Method for transmitting video and/or audio signals of a camera having a compression of the received signals, a modulation of the compressed signals, a sending of the modulated signals receiving the transmitted signal, demodulating the received signal, decompressing the demodulated signal whereby the compressing/decompressing is performed according to the DVCPRO standard and the modulation/demodulation is performed according to the COFDM standard.
